(19) United States
(12) Patent Application Publication
(10) Pub. No.: US 2015/0302960 A1
(43) Pub. Date: Oct. 22, 2015

(54) MANUFACTURING METHOD OF A POWDER FOR COMPACTING RARE EARTH MAGNET AND THE RARE EARTH MAGNET OMITTING JET MILLING PROCESS

(71) Applicant: XIAMEN TUNGSTEN CO., LTD., Xiamen, Fujian (CN)

(72) Inventors: Hiroshi NAGATA, Xiamen (CN); Chonghu WU, Xiamen (CN)

(73) Assignee: XIAMEN TUNGSTEN CO., LTD., Xiamen, Fujian (CN)

(21) Appl. No.: 14/441,944

(22) PCT Filed: Nov. 8, 2013
(86) PCT No.: PCT/CN2013/086806

§ 371 Date: May 11, 2015

(30) Foreign Application Priority Data
Nov. 9, 2012 (CN) 201210448946.5

(51) Int. Cl. H01F 1/057; C21D 6/00; C22C 1/06; C22C 38/00; C22C 38/16; C22C 38/14; C22C 38/06; C22C 33/00; B22F 9/04; B22F 3/12; B22F 3/04; H01F 1/08; H01F 1/053; H01F 1/055; H01F 41/02; C21D 3/06

(52) U.S. Cl. CPC H01F 1/0573; C21D 3/06; C21D 6/007; C22C 1/06; C22C 38/005; C22C 38/16; C22C 38/002; C22C 38/14; C22C 38/06; C22C 33/00; B22F 9/04; B22F 3/12; B22F 3/04; H01F 1/086; H01F 1/0536; H01F 1/0557; H01F 1/0577; H01F 41/0266

(57) ABSTRACT

The present invention discloses manufacturing methods of a powder for compacting rare earth magnet and rare earth magnet that omit jet milling process, which comprise the steps as follows: 1) casting: casting the molten alloy of rare earth magnet raw material by strip casting method to obtain a quenched alloy with average thickness in a range of 0.2˜0.4 mm; 2) hydrogen decrepitation: decrepitating the quenched alloy hydrogen under a hydrogen pressure between 0.01˜1 MPa for 0.5˜24 h to obtain the powder. The present invention improves the manufacturing processes which are before the process of jet milling for omitting the process of jet milling, thus simplifying the process; which may also acquire a low cost production by efficiently using the precious rare earth resource.

### FIELD OF THE INVENTION

The present invention relates to magnet manufacturing technique field, especially to manufacturing methods of a powder for compacting rare earth magnet and the rare earth magnet that omit jet milling process.

### BACKGROUND OF THE INVENTION

Rare earth magnet is based on intermetallic compound R₂T₁₄B, thereinto, R is rare earth element, T is iron or transition metal elements replacing iron or part of iron, B is boron. Rare earth magnet is called the king of the magnet with excellent magnetic properties, the max magnetic energy product (BH)max is ten times higher than that of the ferrite magnet (Ferrite), besides, the rare earth magnet has good machining property, the operation temperature can reach 200° C., it has a hard quality, a stable performance, a high cost performance and a wide applicability.

There are two types of rare earth magnets depending on the manufacturing method: one is sintered magnet and the other one is bonded magnet. The sintered magnet has wider applications. In the conventional technique, the process of sintering the rare earth magnet is normally performed as follows: raw material preparing→melting→casting→hydrogen decrepitation (HD)→jet milling (JM)→compacting under a magnetic field→sintering→heat treatment→magnetic property evaluation→oxygen content evaluation of the sintered magnet.

Crushing method of rare earth magnet is usually applied with a two-stage crushing method: hydrogen decrepitation (HD) and jet milling (JM). Hydrogen decrepitation (HD) is a method for the rare earth magnet alloy (for example NdFeB magnet alloy) to absorb hydrogen, with the absorption of hydrogen, the hydrogen absorption part of the alloy may expand so that the inner of the alloy breaks or cracks, that is a relatively simple grinding method. Jet milling (JM) is a method for ultrasonically accelerating the powder in almost none oxygen atmosphere, the powders impact mutually, then the impacted powder is classified as desirable powder and R rich ultra fine powder (below 1 μm). It is a common belief that jet milling is a necessary process, the reason is that, the powder with certain centralized particle size distribution may improve the compacting property, orientation, coercivity and other magnet properties.

Compared to other powder particles with less content of rare earth element R (with larger particle size), R rich ultra fine powder is oxygenated more easily, if sintering the green compacts without removing the R rich ultra fine powder, the rare earth element may be significantly oxygenated in the sintering process, resulting in low production of crystallization phase with main phase R₂T₁₄B as rare earth element R is used to bind with oxygen. However, the process of removing ultra fine powder needs powder classifying device, special filter to recycle the inert gases and other complicated devices. The classifying process in jet milling methods needs a screen shape rotating blade with a high rotating speed, however, to ensure a stable rotating speed in 3000 rpm˜5000 rpm, it may cause the consumption of the rotating blade, bearing and other precise components. Besides, the departed ultra fine powder of the rare earth magnet alloy may be easily reacted with oxygen and burn fiercely that brings danger to the operators when cleaning the jet milling device.

With the continuous development of low oxygenation technique in the rare earth magnet manufacturing and the continuous improvement of the air-tightness technique from the compacting to the sintering processes, oxygenation may rarely happen during the compacting to the sintering processes. Therefore, oxygenation may mainly happen during the jet milling process that needs large amount of jet steam, for example, when the oxygen content in the jet milling is about 10000 ppm, the oxygen content of the obtained sintered magnet is about 2900 ppm˜5300 ppm; however, for obtaining the sintered magnet with a lower oxygen content by decreasing the oxygen content of the jet steam, there may need to increase the investment cost and the manufacturing cost.

In addition, as rare earth resource is continuously reduced with continuous mining, rare earth is more and more precious, so that it has to efficiently use the rare earth. A loss of about 0.5˜3% of the powder in the jet milling process may gradually become a problem.

### SUMMARY OF THE INVENTION

One object of the present invention is to overcome the disadvantages of the conventional technology and to provide a manufacturing method of a powder for compacting rare earth magnet omitting jet milling process, which improves the manufacturing processes which are before the process of the jet milling for omitting the process of jet milling, thus simplifying the manufacturing process; which may acquire a low cost production by efficiently using the precious rare earth resource.

The technical proposal of the present invention to solve the technical problem is that:

A manufacturing method of a powder for compacting rare earth magnet omitting jet milling process, the rare earth magnet comprises R₂T₁₄B main phase, R is selected from at least one rare earth element including yttrium, and T is selected from at least one transition metal element including the element Fe; the method comprising the steps of:

1) casting: casting the molten alloy of rare earth magnet raw material by strip casting method to obtain a quenched alloy with average thickness in a range of 0.2˜0.4 mm;

2) hydrogen decrepitation: decrepitating the quenched alloy under a hydrogen pressure between 0.01˜1 MPa for 0.5˜24 h to obtain the powder.

The rare earth magnet of the present invention is sintered magnet.

In another preferred embodiment, in weight ratio, more than 95% of the quenched alloy has a thickness in a range of 0.1˜0.7 mm.

The rare earth magnet of the present invention further comprises, except necessary components R, T, B to form the R₂T₁₄B main phase, an adding element M with a proportion of 0.01 at %˜10 at %, M is selected from at least one of the elements Al, Ga, Ca, Sr, Si, Sn, Ge, Ti, Bi, C, S or P.

In another preferred embodiment, it further comprises a process of screening the powder by a 300˜800 mesh screen.

In another preferred embodiment, it further comprises a powder dehydrogenation process.

In another preferred embodiment, it further comprises a process that after the hydrogen decrepitation process, screening the powder by a 300˜800 mesh screen after being processed by a mechanical crusher or a mechanical grinder.

In another preferred embodiment, the quenched alloy is obtained in a cooling rate between 10²° C./s˜10⁴° C./s and in an average cooling rate between 1*10³° C./s˜8*10³° C./s.

In another preferred embodiment, the hydrogen decrepitation process is performed after preheating the quenched alloy to a temperature of 150° C.˜600° C.s.

In another preferred embodiment, the powder is obtained by maintaining the quenched alloy for 1˜6 hours in a hydrogen pressure between 0.01 MPa˜1 MPa and then screening the quenched alloy by a 300˜800 mesh screen.

In another preferred embodiment, the proportion of element Co is below 1 at % in the raw material of the rare earth magnet.

It has to be noted that, the process of the jet milling is omitted in the following processes, the powder after hydrogen decrepitation is added with some organic additive, then is formed in a magnetic field, as the formability of the powder obtained in the present invention is different from the conventional powder, it is better to choose a conventional mold for performing the two stage compacting method comprising magnetic field compacting and isostatic pressing (CIP), the compacts are degreased and degassed in vacuum, then the compacts are sintered in vacuum or in inert gas in a temperature of 900° C.˜1140° C., the sintered magnet has an oxygen content below 1000 ppm, the reason is that, without the process of the jet milling, the probability of the powder's exposure to gas may be reduced, so that it may obtain magnet with low oxygen content and high properties.

In another preferred embodiment, the organic additive is selected from mineral oil, synthetic oil, animal and vegetable oil, organic esters, paraffin, polyethylene wax or modified paraffin. The weight ratio of the organic additive and the rare earth alloy magnetic powder is 0.01˜1.5:100.

In another preferred embodiment, the organic ester is methyl caprylate. In the present invention, the methyl caprylate has very well lubrication effect, as it is easily volatized in high temperature, even the additive amount has 1.5% of the weight of the rare earth alloy magnetic powder, there would be little amount of elements C, O left in the sintered magnet, compared to ordinary additive, the methyl caprylate may not only have a better lubricant effect and improve the orientation of degree and formability effect, but also ensure the Br, Hcj and (BH)max of the sintered magnet from being influenced.

In another preferred embodiment, in atomic percent, the component of the quenched alloy is RₑT_{f}A_{g}JₕGᵢDₖ, R is Nd or comprising Nd and selected from at least one of the elements La, Ce, Pr, Sm, Gd, Dy, Tb, Ho, Er, Eu, Tm, Lu and Y; T is Fe or comprising Fe and selected from at least one of the elements Ru, Co and Ni; A is B or comprising B and selected from at least one of the elements C or P; J is selected from at least one of the elements Cu, Mn, Si and Cr; the element G is selected from at least one of the elements Al, Ga, Ag, Bi and Sn; D is selected from at least one of the elements Zr, Hf, V, Mo, W, Ti and Nb; and the subscripts are configured as:

12≦e≦16,

5≦g≦9,

0.05≦h≦1,

0.2≦i≦2.0,

k is 0≦j≦4,

f=100−e−g−h−i−k.

It has to be noted that, as the elements O, N are impurities may be easily added during operation, the alloy powder may mix with a little regular amount of the elements O, N.

In another preferred embodiment, the strip casting method can apply with existing known water-cooling cant casting method, water-cooling plain disk casting method, double roller method, single roller method or centrifugal casting method.

A second object of the present invention is to provide a manufacturing method of rare earth magnet omitting jet milling process.

A manufacturing method of rare earth magnet omitting jet milling process, the rare earth magnet comprises R₂T₁₄B main phase, R is selected from at least one rare earth element including yttrium, and T is selected from at least one transition metal element including Fe; the method comprising the steps of:

casting the molten alloy of rare earth magnet raw material by strip casting method to obtain a quenched alloy with average thickness in a range of 0.2˜0.4 mm; decrepitating the quenched alloy hydrogen decrepitation in a hydrogen pressure between 0.01˜1 MPa for 0.5˜24 h, dehydrogenating the quenched alloy and screening the alloy by 300˜800 mesh screen to obtain the powder; and

compacting the powder in a two section compacting method comprising magnetic field compact and isostatic pressing compact to make a green compact; and

sintering the green compact to make a permanent magnet.

Compared to the conventional technology, the present invention has following advantages:

1. The present invention improves the manufacturing processes which are before the process of jet milling, so as to omit jet milling process, thus simplifying the manufacturing process, efficiently saving the precious rare earth resource and obtaining low cost manufacturing;

2. The present invention omits jet milling method that have advantages of saving rare earth resource, simplifying manufacturing process, lowering manufacturing cost, and further capable of obtaining rare earth sintered magnet with oxygen content below 1000 ppm;

3. As the jet milling process is omitted, it may avoid oxygenation during jet milling process, so as to be non-oxide process, therefore the mass production of the magnet with low oxygen content and super high property may be possible;

4. Only hydrogen decrepitation is performed in the hydrogen decrepitation process, therefore the final powder has less fines, and the magnet with BH(max) exceeding 52 MG0e may be obtained.

### DETAILED DESCRIPTION OF THE EMBODIMENTS

The present invention will be further described with the embodiments.

### Embodiment 1

In the raw material preparing process: Nd with 99.5% purity, industrial Fe—B, industrial pure Fe, Co with 99.9% purity and Cu, Al, Zr with 99.5% purity are prepared, counted in atomic percent, and prepared in RₑT_{f}A_{g}JₕGᵢDₖ components.

The contents of the elements are shown in TABLE 1:

TABLE 1
proportioning of each element

| R | T | | A | J | G | D |
|---|---|---|---|---|---|---|
| Nd | Fe | Co | B | Cu | Al | Zr |
| 12.5 | 80 | 0.4 | 6 | 0.2 | 0.6 | 0.3 |

Preparing 16 copies by respectively weighing in accordance with TABLE 1, each copy has 100 Kg raw material.

In the melting process: one copy of the prepared raw material is put into a aluminum oxide made crucible each time, an intermediate frequency vacuum induction melting furnace is used to melt the raw materials in 10⁻² Pa vacuum below 1500° C.

In casting process: Ar gas is filled to the melting furnace so that the Ar pressure would reach 50000 Pa after the process of vacuum melting, then using following casting methods: the quenched alloy is obtained in a cooling rate of 10²° C./s˜10⁴° C./s with average cooling rate 1*10³° C./s˜8*10³° C./s, the casting manners and average strip thickness are shown in TABLE 2.

The thickness of the quenched alloy depends on the rotating rate of the roller and the rotating rate of the rotating disk.

The strip thickness of the quenched alloy strip is measured by a micrometer and measured for 100 strips each time, and the strip thicknesses are recorded. When measuring, it has to be random sampled to measure the thickness, one strip is only once measured, the measured position is near to the geometric center of the alloy strip, and the strip can not be bended for measuring. The samples should be taken from upper layer, central layer and lower layer.

To avoid impurity and pollution, the staff should wear disposable grooves when measuring.

As can be seen from the measuring result, in weight ratio, the thicknesses of 95% of the quenched alloy of Embodiment 3, Embodiment 4, embodiment 5 and embodiment 11, embodiment 12, embodiment 13 are in a range of 0.1˜0.7 mm.

In the hydrogen decrepitation process: the hydrogen decrepitation furnace with the quenched alloy is pumped at room temperature, then filling with hydrogen with 99.5% purity so that the hydrogen pressure would reach 0.1 Mpa, after leaving it for 2 hours, heating the furnace and pumping to be vacuum at the same time, keeping vacuum in 500° C. for 2 hours, and then cooling it, getting out the powder after hydrogen decrepitation.

Taking the powder out, firstly the powder is put into a jaw crusher, then the powder is screened by a 300 mesh ultrasonic screen, the screened powder is then collected. The screened fine powder has a recovery rate of over 97%.

Methyl caprylate is added to the screened powder, the additive amount is 0.2% of the weight of the screened powder, the mixture is comprehensively blended by a V-type mixer.

In the compacting process under a magnetic field: a transversed type magnetic field molder is used, the powder with methyl caprylate is compacted in once to form a cube with sides of 25 mm in an orientation magnetic filed of 1.8 T and under a compacting pressure of 0.2 ton/cm², then the once-forming cube is demagnetized in a 0.2 T magnetic filed. The once-forming compact (green compact) is sealed so as not to expose to air, the compact is secondary compacted by a secondary compact machine (isostatic pressing compacting machine) under a pressure of 1.4 ton/cm².

In the examination of corner-breakage of the green compact: permanent magnet material is unqualified with even a little bit corner-breakage, by visual inspection, if there are broken, corner breakage or crack with a length of more than 1 mm, it may be determined as unqualified and the defective rate is counted.

In the sintering progress: the green compact is moved to a sintering furnace to sinter, in a vacuum of 10⁻³ Pa and respectively maintained for 2 hours in 200° C. and for 2 hours in 900° C., then sintering for 2 hours in 1050° C., after that filling Ar gas into the sintering furnace so that the Ar pressure would reach 0.1 MPa, then cooling it to room temperature.

In the heating progress: the sintered magnet is heated for 1 hour in 620° C. in the atmosphere of high purity Ar gas, then cooling it to room temperature and taking it out.

In magnetic property evaluation process: the sintered magnet is tested by NIM-10000H type nondestructive testing system for BH large rare earth permanent magnet from China Jiliang University.

In the oxygen content of sintered magnet evaluation process: the oxygen content of the sintered magnet is measured by EMGA-620W type oxygen and nitrogen analyzer from HORIBA company of Japan.

The magnetic property evaluation results of the embodiments and the comparing samples are shown in TABLE 2:

TABLE 2
The magnetic property and oxygen content evaluation of the
embodiments and the comparing samples.

| | | | | Defective | | | | | Oxygen |
|---|---|---|---|---|---|---|---|---|---|
| | | | Average | rate of | | | | | content of |
| | | | strip | the | | | | | the sintered |
| | | Casting | thickness | compact | Br | | | (BH)max | magnet |
| No. | | manner | (mm) | (%) | (kGs) | Hcj (k0e) | SQ (%) | (MG0e) | (ppm) |
| 1 | comparing | Single | 0.08 | 19 | 12.8 | 11.6 | 87.5 | 38.4 | 569 |
| 2 | comparing | roller | 0.1 | 0.1 | 14.5 | 13.3 | 98.3 | 53.6 | 280 |
| 3 | embodiment | for | 0.2 | 0 | 14.8 | 13.4 | 99.2 | 54.2 | 287 |
| 4 | embodiment | quenching | 0.3 | 0 | 14.8 | 13.2 | 99.3 | 54.1 | 278 |
| 5 | embodiment | | 0.4 | 0 | 14.8 | 13.1 | 97.8 | 54.2 | 267 |
| 6 | comparing | | 0.5 | 0.3 | 14.6 | 13.1 | 98.1 | 53.2 | 258 |
| 7 | comparing | | 0.6 | 30 | 14.6 | 12.5 | 86.8 | 48.2 | 324 |
| 8 | comparing | | 1 | 80 | 13 | 10.3 | 81.4 | 48.1 | 674 |
| 9 | comparing | water- | 0.07 | 25 | 12.6 | 11.4 | 78.5 | 35.4 | 828 |
| 10 | comparing | cooling | 0.1 | 0.3 | 14.5 | 13.3 | 97.8 | 53.6 | 272 |
| 11 | embodiment | with | 0.2 | 0 | 14.8 | 13.3 | 99.2 | 53.2 | 275 |
| 12 | embodiment | rotating | 0.3 | 0 | 14.8 | 13.4 | 99.3 | 53.4 | 275 |
| 13 | embodiment | disk | 0.4 | 0 | 14.8 | 13.3 | 99.1 | 53.4 | 272 |
| 14 | comparing | | 0.5 | 0.2 | 14.8 | 13.1 | 98.2 | 52.6 | 267 |
| 15 | comparing | | 0.8 | 54 | 13.8 | 11.2 | 87.3 | 45.7 | 678 |
| 16 | comparing | | 10 | 76 | 12.7 | 10.3 | 83.2 | 34.3 | 849 |

As can be seen from above embodiment, the quenched alloy has the best condition of thickness. As the raw material with a relative thinner strip has more amorphous phase and isometric crystal, which may result in bad orientation degree, reducing of the contents of Br, (BH)max; in addition, due to the easily oxygenated ultra fine powder, the oxygen content may increase, and the properties of coercivity and squareness may be worse consequently. As the raw material with a relative thicker strip has more α-Fe and R₂Fe₁₇ phase, and large amount of Nd rich phase, which may lead to bad orientation degree and reducing of the contents of Br, (BH)max; besides, due to the easily oxygenated Nd rich phase, the oxygen content may increase, and the properties of coercivity and squareness may be worse consequently.

Besides, the present invention is capable of controlling the average cooling rate of the molten alloy to obtain a strip casting with evenly crystals and reducing the number of oversize crystals and undersize crystals, so that even omitting jet milling process, it can obtain desirable powder for compacting.

### Embodiment 2

In the raw material preparing process: Nd with 99.5% purity, industrial Fe—B, industrial pure Fe, Co with 99.9% purity and Mn, Ga, Nb with 99.5% purity are prepared, counted in atomic percent, and prepared in RₑT_{f}A_{g}JₕGᵢDₖ components.

The contents of the elements are shown in TABLE 3:

TABLE 3
proportioning of each element

| R | T | | A | J | G | D |
|---|---|---|---|---|---|---|
| Nd | Fe | Co | B | Mn | Ga | Nb |
| 12.8 | 80.1 | 0.3 | 6 | 0.2 | 0.3 | 0.3 |

Preparing 100 Kg raw material by weighing in accordance with TABLE 3.

In the melting process: the prepared raw material is put into an aluminum oxide made crucible, an intermediate frequency vacuum induction melting furnace is used to melt the raw material in 10⁻¹ Pa vacuum below 1600° C.

In casting process: Ar gas is filled to the melting furnace so that the Ar pressure would reach 80000 Pa after vacuum melting, then on a water-cooling casting plain disk, the material is casted to the quenched alloy in a cooling rate of 10²° C./s˜10⁴° C./s with average cooling rate 1*10³° C./s˜8*10³° C./s. The alloy is then divided into 16 copies.

The thickness of the quenched alloy depends on the rotating rate of the water-cooling casting plain disk.

The strip thickness of the quenched alloy strip is measured by a micrometer and measured for 100 strips each time, and the strip thicknesses are recorded. When measuring, it has to be random sampled to measure the thickness, one strip is only once measured, the measured position is near to the geometric center of the alloy strip, the strip can not be bended for measuring. The samples should be taken from upper layer, central layer and lower layer.

To avoid impurity and pollution, the staff should wear disposable grooves when measuring.

As can be seen from the measuring result, the average thicknesses of the quenched alloy is 0.3 mm, in weight ratio, 98% of the quenched alloy has the thickness in a range of 0.1˜0.7 mm.

In the hydrogen decrepitation process: the hydrogen decrepitation furnace with one copy of the quenched alloy of 0.3 mm average thickness is pumped to be vacuum in room temperature, then respectively filling with hydrogen of 99.5% purity and so that the hydrogen pressures would respectively reach the pressures of No. 1˜7 shown in Table 4, after leaving it for 6 hours, pumping the furnace to be vacuum in 500° C. for 2 hours, and then cooling the alloy. A specimen is taken out after hydrogen decrepitation, the specimen firstly passes through a plane disk crusher, and then collected by a 500 mesh screen.

And in another experiment, the hydrogen decrepitation furnace with one copy of the quenched alloy of 0.3 mm average thickness is pumped to be vacuum in room temperature, then respectively preheated to the temperatures of No. 8˜16 shown in Table 5, then filling with hydrogen with 99.9% purity so the hydrogen pressure may reach 0.2 Mpa, after leaving for 6 hours, vacuuming the furnace in 500° C. for 2 hours, and then cooling it. A specimen is taken out after hydrogen decrepitation, and collected by a 800 mesh screen for recovering the screened powder. The recovery rate of the screened fine powder is over 99.9%.

Methyl caprylate is added to the screened powder, the additive amount is 0.4% of the weight of the screened powder, the mixture is comprehensively blended by a V-type mixer for 3 hours.

In the compacting process under a magnetic field: a transversed type magnetic field molder is used, the powder with methyl caprylate is compacted in once to form a cube with sides of 25 mm in an orientation filed of 1.8 T and under a compacting pressure of 0.4 ton/cm², then the once-forming cube is demagnetized in a 0.1 T magnetic filed. The once-forming compact (green compact) is sealed so as not to expose to air, the compact is secondary compacted by a secondary compact machine (isostatic pressing compacting machine) under a pressure of 1.0 ton/cm².

In the examination of corner-breakage of the green compact: permanent magnet material is unqualified with even a little bit corner-breakage, by visual inspection, if there are broken, corner breakage or crack with a length of more than 1 mm, it may be determined as unqualified and the defective rate is counted.

In the sintering progress: the green compact is moved to the sintering furnace to sinter, in a vacuum of 10⁻³ Pa and respectively maintained for 2 hours in 200° C. and for 2 hours in 900° C., then sintering for 4 hours in 1020° C., after that filling Ar gas into the sintering furnace so that the Ar pressure would reach 0.1 MPa, then cooling it to room temperature.

In the heating progress: the sintered magnet is heated for 1 hour in 540° C. in the atmosphere of high purity Ar gas, then cooling it to room temperature and taking it out.

In magnetic property evaluation process: the sintered magnet is tested by NIM-10000H type nondestructive testing system for BH large rare earth permanent magnet from China Jiliang University.

In the oxygen content of sintered magnet evaluation process: the oxygen content of the sintered magnet is measured by EMGA-620W type oxygen and nitrogen analyzer from HORIBA company of Japan.

The magnetic property evaluation results of the embodiments and the comparing samples are shown in TABLE 4 and TABLE 5:

TABLE 4
The magnetic property and oxygen content evaluation of the
embodiments and the comparing samples in different pressures.

| | | | Defective | | | | | Oxygen |
|---|---|---|---|---|---|---|---|---|
| | | | rate of | | | | | content of |
| | | hydrogen | the | | | | | the sintered |
| | | pressure | compact | Br | | | (BH)max | magnet |
| No. | | (atm) | (%) | (kGs) | Hcj (k0e) | SQ (%) | (MG0e) | (ppm) |
| 1 | comparing | 0.07 | 89 | 12.5 | 9.8 | 86.6 | 31.3 | 345 |
| | sample | | | | | | | |
| 2 | embodiment | 0.1 | 0.1 | 14.4 | 12.9 | 98.6 | 53.6 | 280 |
| 3 | embodiment | 0.5 | 0 | 14.7 | 13 | 99.1 | 54.2 | 287 |
| 4 | embodiment | 1 | 0 | 14.7 | 13.1 | 99.1 | 54.1 | 278 |
| 5 | embodiment | 5 | 0 | 14.7 | 13.1 | 98.9 | 54.2 | 267 |
| 6 | embodiment | 10 | 0.3 | 14.5 | 13.1 | 98.2 | 53.2 | 258 |
| 7 | comparing | 15 | 12 | 12.8 | 12.5 | 78.5 | 48.2 | 324 |
| | sample | | | | | | | |

TABLE 5
The magnetic property and oxygen content evaluation of the
embodiments in different preheating temperature of the quenched alloy.

| | | | Defective | | | | | |
|---|---|---|---|---|---|---|---|---|
| | | | rate of | | | | | Oxygen |
| | | Preheating | the | | | | | content of |
| | | temperature | compact | Br | | SQ | (BH)max | the sintered |
| No. | | ( ) | (%) | (kGs) | Hcj (k0e) | (%) | (MG0e) | magnet (ppm) |
| 8 | embodiment | 25 | 0.6 | 14.5 | 13.3 | 95.6 | 52.6 | 356 |
| 9 | embodiment | 100 | 0.5 | 14.6 | 13.3 | 97.8 | 53.6 | 345 |
| 10 | embodiment | 150 | 0 | 14.8 | 13.3 | 99.2 | 53.2 | 234 |
| 11 | embodiment | 200 | 0 | 14.8 | 13.3 | 99.1 | 53.4 | 236 |
| 12 | embodiment | 300 | 0 | 14.8 | 13.1 | 99.1 | 52.6 | 216 |
| 13 | embodiment | 400 | 0 | 14.8 | 13.2 | 99.2 | 53.2 | 215 |
| 14 | embodiment | 500 | 0 | 14.8 | 13.3 | 98.2 | 53.1 | 156 |
| 15 | embodiment | 600 | 0.3 | 14.6 | 13.2 | 95.2 | 51.4 | 349 |
| 16 | embodiment | 700 | 0.4 | 14.5 | 13.2 | 94.6 | 51.2 | 378 |

As can be seen from TABLE 4, the present invention has the most appropriate decrepitation pressure in the hydrogen decrepitation process: in low pressure, the alloy can not fully absorb hydrogen, so that it can not be fully crushed; however, if the hydrogen pressure is too high, there may not only has safety risks, but also can not be fully crushed, the reason is that if the main phase and Nd rich absorb hydrogen at the same time, the decrepitation may be difficult.

As can be seen from TABLE 5, there also discloses a proper preheating temperature range for the quenched alloy at the beginning of the hydrogen decrepitation, however, with the increasing of the initial temperature, the hydrogen amount mixed to the main phase may decrease consequently, and crack may happen along the Nd rich phase, furthermore, if the temperature reaches 600° C., the hydrogen absorbed by the Nd rich phase may decrease, thus making it difficult to crush.

Same as the Embodiment 1, this embodiment of the present invention is capable of controlling the average cooling rate of the molten alloy to obtain a strip casting with evenly crystals and reducing the number of oversize crystals and undersize crystals, so that even omitting jet milling process, it can obtain desirable powder for compacting.

### Embodiment 3

In the raw material preparing process: Nd with 99.5% purity, industrial Fe—B, industrial pure Fe, Co with 99.9% purity and Pr, Dy, Si, Ag, Ti with 99.9% purity are prepared, counted in atomic percent, and prepared in RₑT_{f}A_{g}JₕGᵢDₖ components.

The contents of the elements are shown in TABLE 6:

TABLE 6
proportioning of each element

| | R | | | T | | A | | J | G | D |
|---|---|---|---|---|---|---|---|---|---|---|
| No. | Nd | Pr | Dy | Fe | Co | B | C | Si | Ag | Ti |
| 1 | 11 | 2.8 | 0.8 | 74.9 | 0 | 6 | 0.25 | 0.05 | 0.2 | 4 |
| 2 | 11 | 2.8 | 0.8 | 74.4 | 0.5 | 6 | 0.25 | 0.05 | 0.2 | 4 |
| 3 | 11 | 2.8 | 0.8 | 73.9 | 1 | 6 | 0.25 | 0.05 | 0.2 | 4 |
| 4 | 11 | 2.8 | 0.8 | 73.4 | 1.5 | 6 | 0.25 | 0.05 | 0.2 | 4 |
| 5 | 11 | 2.8 | 0.8 | 72.9 | 2 | 6 | 0.25 | 0.05 | 0.2 | 4 |

Preparing in accordance with the five experiments in TABLE 6, each number has been prepared with 100 Kg raw material by respectively weighing. In the melting process: 100 Kg of the prepared raw material is put into a magnesium oxide made crucible each time, an intermediate frequency vacuum induction melting furnace is used to melt the raw material in 10⁻¹ Pa vacuum below 1700° C.

In casting process: Ar gas is filled to the melting furnace to 90000 Pa after vacuum melting, then on a water-cooling casting plain disk, the quenched alloy is obtained in a cooling rate of 10²° C./s˜10⁴° C./s with average cooling rate of 1*10³° C./s˜8*10³° C./s.

The thickness of the quenched alloy depends on the rotating rate of water-cooling casting plain disk.

The strip thickness of the quenched alloy strip is measured by a micrometer and measured for 100 strips each time, and the strip thicknesses are recorded. When measuring, it has to be random sampled to measure the thickness, one strip is only once measured, the measured position is near to the geometric center of the alloy strip, the strip can not be bended for measuring. The samples should be taken from upper layer, central layer and lower layer.

To avoid impurity and pollution, the staff should wear disposable grooves when measuring.

As can be seen from the measuring result, the average thickness of the quenched alloy is 0.3 mm, in weight ratio, 95% of the quenched alloy has the thickness in a range of 0.1˜0.7 mm.

In the hydrogen decrepitation process: the hydrogen decrepitation furnace with the quenched alloy of average thickness 0.3 mm is pumped to be vacuum in room temperature, heating to 200° C., then filling with hydrogen with 99.9% purity so that the hydrogen pressure would reach 0.1 Mpa, after leaving it for 0.5 hours, heating the furnace and pumping to be vacuum at the same time, keeping vacuum in 500° C. for 2 hours, and then cooling it, taking a specimen out after hydrogen decrepitation.

After taking out the specimen, firstly passing the specimen through a continuous mortar crusher, then the specimen is screened by a 300 mesh screen, so the screened specimen (powder) is collected. The screened fine powder has a recovery rate of over 99.95%.

Methyl caprylate is added to the screened powder, the additive amount is 0.4% of the weight of the screened powder, the mixture is comprehensively blended by a V-type mixer for 1 hour.

In the compacting process under a magnetic field: a transversed type magnetic field molder is used, the powder with methyl caprylate is compacted in once to form a cube with sides of 25 mm in an orientation filed of 1.6 T and under a compacting pressure of 0.4 ton/cm², then the once-forming cube is demagnetized in a 0.1 T magnetic filed. The once-forming compact (green compact) is sealed so as not to expose to air, the compact is secondary compacted by a secondary compact machine (isostatic pressing compacting machine) under a pressure of 1.0 ton/cm².

In the examination of corner-breakage of the green compact: permanent magnet material is unqualified with even a little bit corner-breakage, by visual inspection, if there are broken, corner breakage or crack with a length of more than 2 mm length, it may be determined as unqualified and the defective rate is counted.

In the sintering progress: the green compact is moved to a sintering furnace to sinter, in a vacuum of 10⁻³ Pa and respectively maintained for 2 hours in 200° C., for 2 hours in 500° C. and for 2 hours in 500° C., then sintering for 4 hours in 1080° C., after that filling Ar gas into the sintering furnace so that the Ar pressure would reach 0.1 MPa, then cooling it to room temperature.

In the heating progress: the sintered magnet is heated for 1 hour in 540° C. in the atmosphere of high purity Ar gas, then cooling it to room temperature and taking it out.

In magnetic property evaluation process: the sintered magnet is tested by NIM-10000H type nondestructive testing system for BH large rare earth permanent magnet from China Jiliang University.

In the oxygen content of sintered magnet evaluation process: the oxygen content of the sintered magnet is measured by EMGA-620W type oxygen and nitrogen analyzer from HORIBA company of Japan.

The magnetic property evaluation results of the embodiments and the comparing samples are shown in TABLE 7:

TABLE 7
The magnetic property and oxygen content evaluation of the
embodiments and the comparing samples.

| | | | | | | | | Oxygen |
|---|---|---|---|---|---|---|---|---|
| | | | | | | | | content of |
| | | Additive | Defective | | | | | the |
| | | amount | rate of the | | | | | sintered |
| | | of Co | compact | Br | | | (BH)max | magnet |
| No. | | (at %) | (%) | (kGs) | Hcj (k0e) | SQ (%) | (MG0e) | (ppm) |
| 1 | Embodiment | 0 | 0 | 13.2 | 18.1 | 99.6 | 42.5 | 232 |
| 2 | Embodiment | 0.5 | 0 | 13.1 | 18 | 98.6 | 42.3 | 254 |
| 3 | Embodiment | 1 | 1 | 13 | 18 | 98.2 | 42.1 | 267 |
| 4 | Comparing | 1.5 | 3 | 12.8 | 17.6 | 95.2 | 40.2 | 278 |
| | sample | | | | | | | |
| 5 | Comparing | 2 | 5 | 12.6 | 17.2 | 93.1 | 35.7 | 289 |
| | sample | | | | | | | |

As can be seen from above embodiments and comparing samples, the crushing method of the present invention has most appropriate additive amount of Co, if the additive amount of Co is too much, it may results in bad crushing effect and increasing of defective compacts.

Based on investigation of the powder by X-ray diffraction, with the increasing of the additive amount of Co, R₂Co₂ and R₂Co₃ crystal can be observed, it can be noted that, metallic compound with Co doesn't absorb hydrogen, thus resulting in bad crushing and formability effects.

Same as the Embodiment 1, this embodiment is capable of controlling the average cooling rate of the molten alloy to obtain a strip casting with evenly crystals and reducing the number of oversize crystals and undersize crystals, so that even omitting jet milling process, it can obtain desirable powder for compacting.

Although the present invention has been described with reference to the preferred embodiments thereof for carrying out the patent for invention, it is apparent to those skilled in the art that a variety of modifications and changes may be made without departing from the scope of the patent for invention which is intended to be defined by the appended claims.

1. A manufacturing method of a powder for compacting rare earth magnet omitting jet milling process, the rare earth magnet comprises R₂T₁₄B main phase, R is selected from at least one rare earth element including yttrium, and T is at least one transition metal element including the element Fe; the method comprising the steps of:
1) casting: casting the molten alloy of rare earth magnet raw material by strip casting method to obtain a quenched alloy with average thickness in a range of 0.2˜0.4 mm;
2) hydrogen decrepitation: decrepitating the quenched alloy under a hydrogen pressure between 0.01˜1 MPa for 0.5˜24 h to obtain the powder.

2. The manufacturing method according to claim 1, wherein in weight ratio, more than 95% of the quenched alloy has a thickness in a range of 0.1˜0.7 mm.

3. The manufacturing method according to claim 2, wherein the quenched alloy is obtained in a cooling rate between 10²° C./s 10⁴° C./s and in an average cooling rate between 1*10³° C./s˜8*10³° C./s.

4. The manufacturing method according to claim 1, further comprising a process of dehydrogenating the powder.

5. The manufacturing method according to claim 2, wherein the rare earth magnet further comprises an adding element M with a proportion of 0.01 at %˜10 at %, the element M is selected from at least one of the elements Al, Ga, Ca, Sr, Si, Sn, Ge, Ti, Bi, C, S or P.

6. The manufacturing method according to claim 2, further comprising a process of passing the powder passing through a 300˜800 mesh screen; or after the hydrogen decrepitation process, passing the powder through a 300˜800 mesh screen after being processed by a mechanical crusher or a mechanical grinder.

7. The manufacturing method according to claim 2, wherein the powder is obtained by preheating the quenched alloy to a temperature of 150° C.˜600° C. and then maintaining the quenched alloy for 1˜6 hours under a hydrogen pressure between 0.01˜1 MPa.

8. The manufacturing method according to claim 2, wherein the proportion of element Co is below 1 at % in a raw material of the rare earth magnet.

9. The manufacturing method according to claim 4, wherein the component of the quenched alloy is RₑT_{f}A_{g}JₕGᵢDₖ counted in atomic percent, R is Nd or comprising Nd and selected from at least one of the elements La, Ce, Pr, Sm, Gd, Dy, Tb, Ho, Er, Eu, Tm, Lu and Y; T is Fe or comprising Fe and selected from at least one of the elements Ru, Co and Ni; A is B or comprising B and selected from at least one of the elements C or P; J is selected from at least one of the elements Cu, Mn, Si and Cr; G is selected from at least one of the elements Al, Ga, Ag, Bi and Sn; D is selected from at least one of the elements Zr, Hf, V, Mo, W, Ti and Nb; and the subscripts are configured as:
12≦e≦16,
5≦g≦9,
0.05≦h≦1,
0.2≦i≦2.0,
k is 0≦j≦4,
f=100−e−g−h−i−k.

10. A manufacturing method of rare earth magnet omitting jet milling process, the rare earth magnet comprises R₂T₁₄B main phase, the element R is selected from at least one rare earth element including yttrium, and the element T is at least one transition metal element including Fe; the method comprising the steps of:
casting the molten alloy of rare earth magnet raw material by strip casting method to obtain a quenched alloy with average thickness in a range of 0.2˜0.4 mm;
decrepitating the quenched alloy in a hydrogen pressure between 0.01˜1 MPa for 0.5˜24 h; dehydrogenating the quenched alloy and passing the alloy through a 300˜800 mesh screen to obtain the powder;
forming the powder in a two section compacting method comprising magnetic field compact and isostatic pressing compact to make a green compact; and
sintering the green compact to make a permanent magnet.

11. The manufacturing method according to claim 3, wherein the rare earth magnet further comprises an adding element M with a proportion of 0.01 at %˜10 at %, the element M is selected from at least one of the elements Al, Ga, Ca, Sr, Si, Sn, Ge, Ti, Bi, C, S or P.

12. The manufacturing method according to claim 3, further comprising a process of passing the powder passing through a 300˜800 mesh screen; or after the hydrogen decrepitation process, passing the powder through a 300˜800 mesh screen after being processed by a mechanical crusher or a mechanical grinder.

13. The manufacturing method according to claim 3, wherein the powder is obtained by preheating the quenched alloy to a temperature of 150° C.˜600° C. and then maintaining the quenched alloy for 1˜6 hours under a hydrogen pressure between 0.01˜1 MPa.

14. The manufacturing method according to claim 3, wherein the proportion of an element Co is below 1 at % in a raw material of the rare earth magnet.
